(19) United States
(12) Patent Application Publication
(10) Pub. No.: US 2009/0300001 A1
(43) Pub. Date: Dec. 3, 2009

(54) SERVER APPARATUS, CATALOG PROCESSING METHOD, AND COMPUTER-READABLE STORAGE MEDIUM

(75) Inventor: Makoto Mihara, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/470,227

(22) Filed: May 21, 2009

(30) Foreign Application Priority Data
May 30, 2008 (JP) 2008-142449

(51) Int. Cl. G06F 17/30; G06Q 30/00

(52) U.S. Cl. 707/5; 705/27; 707/104.1; 707/E17.109; 707/E17.044; 707/3; 707/E17.005

(57) ABSTRACT

Some embodiments of the present invention provide that a web application server reads catalog information, and selects grouping data. Then, the web application server sets web-application-server grouping. When an instruction on execution of grouping is issued from a client PC, the web application server registers catalog data items for individual groups. When association data is selected by the client PC, the web application server registers association information to a database.

### BACKGROUND OF THE INVENTION

1. Field of the Invention

The present invention relates to a server apparatus which manages electronic catalogs, a catalog processing method, and a computer-readable storage medium.

2. Description of the Related Art

Electronic catalog servers are generally known as information processing apparatuses which manage electronic catalogs. In general, a technique of managing an electronic catalog by dividing the electronic catalog into individual pages, arbitrarily combining catalog data items corresponding to the individual pages, and outputting the combined catalog data items has been realized. As the related art, Japanese Patent Laid-Open No. 2005-108127 discloses a method for associating page data items of a catalog with one another in advance so that, when output of a certain page is instructed, pages associated with the instructed page are simultaneously output.

In such a system in the related art, after an electronic catalog is registered, an administrator should check all pages of the catalog so that the pages are divided into groups. This is a considerable burden for a user. Furthermore, there arises a problem in that, since output of only groups which are permitted by the administrator is allowed for the user, it is difficult for the user to freely perform output of desired catalogs.

### SUMMARY OF THE INVENTION

The present invention provides a method for constituting a catalog database having excellent usability by registering catalog information items after the catalog information items are categorized into groups taking searching requests to be issued by a user into consideration, and reflecting results of the searching requests issued by the user so that burden for a catalog registrant is reduced.

According to an embodiment of the present invention, there is provided a server apparatus which manages electronic catalogs including a storage unit configured to store product information associated with catalog information and a catalog data file including the catalog information, the catalog data file being divided into pages, a group generation unit configured to analyze the catalog data file which has been divided into pages and to generate different group information items having different properties, and a registration unit configured to set different priority information items to the different group information items generated by the group generation unit in accordance with the properties and to register the group information items in the storage unit.

According to another embodiment of the present invention, there is provided a catalog processing method of a server apparatus which manages electronic catalogs. The catalog processing method includes a step of analyzing product information associated with catalog information and a catalog data file which includes the catalog information and which is divided into pages, the product information and the catalog data file being stored in a storage unit, and generating different group information items having different properties, and a step of setting different priority information items to the generated different group information items in accordance with the properties, and registering the group information items in the storage unit.

Accordingly, a catalog database having excellent usability is constituted by registering catalog information items after the catalog information items are categorized into groups taking searching requests to be issued by a user into consideration, and reflecting results of the searching requests issued by the user so that burden for a catalog registrant is reduced.

Further features of the present invention will become apparent from the following description of exemplary embodiments with reference to the attached drawings.

### BRIEF DESCRIPTION OF THE DRAWINGS

FIG. 1 is a diagram illustrating an example of an information processing system according to an embodiment of the present invention.

FIG. 2 is a block diagram illustrating a configuration of an information processing apparatus according to the embodiment.

FIG. 3 is a block diagram illustrating a module configuration of the information processing system according to this embodiment.

FIG. 4 is a diagram illustrating table information blocks managed in a database shown in FIG. 3.

FIG. 5 is a diagram illustrating a grouping management table for a catalog managed in the database of FIG. 3.

FIG. 6 is a flowchart illustrating an example of a data processing procedure of a data processing system according to this embodiment.

FIG. 7 is a diagram illustrating an example of a catalog-registration-function list screen displayed in a client PC shown in FIG. 3.

FIG. 8 is a diagram illustrating an example of a product-master registration screen displayed in the client PC of FIG. 3.

FIG. 9 is a diagram illustrating an example of a screen which is used to select catalog data to be registered and which is displayed in the client PC of FIG. 3.

FIG. 10 is a diagram illustrating an example of a screen which is used to confirm data files to be registered and which is displayed in the client PC of FIG. 3.

FIG. 11A is a diagram illustrating detailed information of tables registered in the database of FIG. 3.

FIG. 11B is a diagram illustrating detailed information of tables registered in the database of FIG. 3.

FIG. 12 is a diagram illustrating an example of a catalog-data processing screen displayed in the client PC of FIG. 3.

FIG. 13 is a diagram illustrating an example of a catalog-data grouping screen displayed in the client PC of FIG. 3.

FIG. 14 is a diagram illustrating examples of tables managed by the database of FIG. 3.

FIG. 15 is a diagram illustrating an example of a data processing procedure of the information processing apparatus according to this embodiment.

FIG. 16 is a flowchart illustrating an example of another data processing procedure of the information processing apparatus according to this embodiment.

FIG. 17 is a flowchart illustrating an example of still another data processing procedure of the information processing apparatus according to this embodiment.

FIG. 18 is a diagram illustrating an example of a product-master search screen displayed in the client PC of FIG. 3.

FIG. 19 is a diagram illustrating an example of a product-master search-result screen displayed in the client PC of FIG. 3.

FIG. 20 is a diagram illustrating an example of a data/content management table managed by the database of FIG. 3.

FIG. 21 is a flowchart illustrating data processing performed by the data processing system included in the information processing system according to this embodiment.

FIG. 22 is a diagram illustrating an example of display of a result of product searching which is displayed by the information processing apparatus according to this embodiment.

FIG. 23 is a diagram illustrating an example of an output-catalog selection screen displayed in the information processing apparatus according to this embodiment.

FIG. 24 is a flowchart illustrating a data processing procedure of the information processing apparatus according to this embodiment.

FIG. 25 is a flowchart illustrating another data processing procedure of the information processing apparatus according to this embodiment.

FIG. 26 is a diagram illustrating a memory map of a computer-readable storage medium which stores various data processing programs which are readable by the information processing apparatus according to this embodiment.

### DESCRIPTION OF THE EMBODIMENTS

Embodiments of the present invention will now be described with reference to the accompanying drawings.

### System Configuration

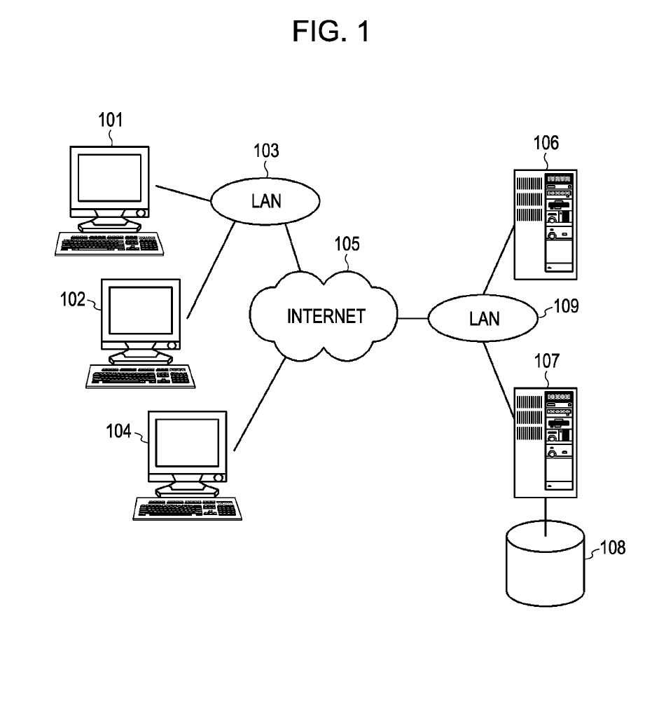

FIG. 1 is a diagram illustrating an example of an information processing system according to an embodiment of the present invention. In the information processing system of FIG. 1, client PCs (Personal Computers) 101, 102, and 104 communicate with an HTTP server 106, and a web application server 107 through the Internet 105, and LANs (Local Area Networks) 103 and 109. The client PCs 101 and 102 are used, for example, when a system administrator newly registers data files, performs system maintenance such as modification of user management information, or issues instructions on product-searching or outputting of product information, for example.

The client PCs 101 and 102 perform data communication with other client PCs and servers, which will be described hereinafter, through the LAN 103.

The client PC 104 is directly connected to the Internet 105. Although a connection configuration of the client PC 104 is different from those of the client PCs 101 and 102, the client PC 104 is used for the same purpose as the client PCs 101 and 102.

The HTTP server 106 receives a request transmitted from the client PCs 101, 102, or 104 through the LAN 109 using an HTTP protocol.

Note that a plurality of web application servers have been registered in the server 106 serving as the HTTP server. The HTTP server 106 appropriately assigns processing to the web application server 107 in accordance with the request transmitted from the client PCs 101, 102, or 104.

The web application server 107 which has received the request performs the processing and returns a result of the processing to the client PCs 101, 102, or 104.

A database 108 stores content such as catalog data and image data, text information such as product information, and system information including user/group information and information on processing performed on a registration data file.

In this system, the server 106, the web application server 107, and the database 108 are used in organic combination with one another so as to function as a Web database system.

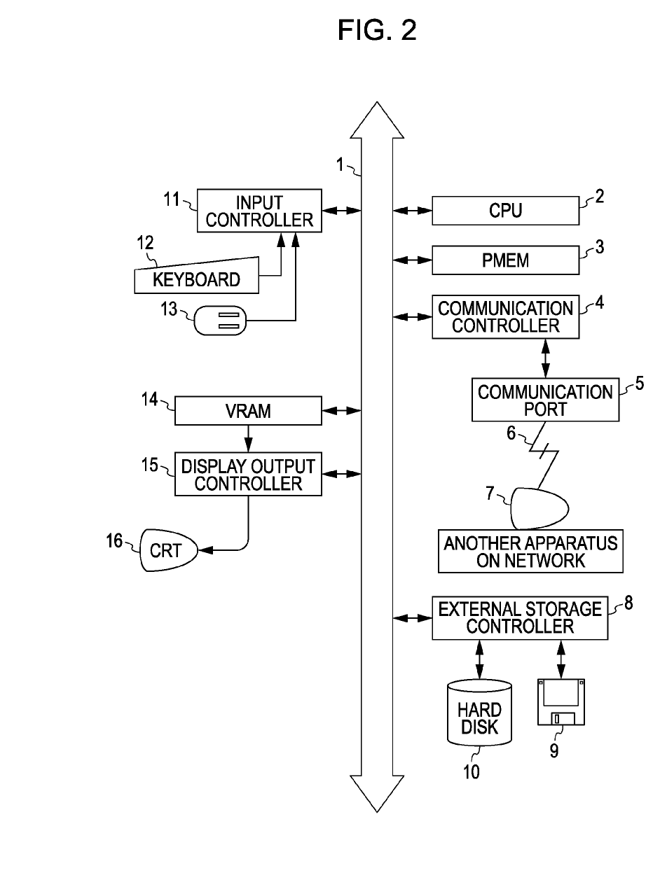

FIG. 2 is a block diagram illustrating a configuration of an information processing apparatus according to this embodiment. Note that the client PCs 101, 102, and 104 and the servers 106 and 107 shown in FIG. 1 have a hardware configuration below.

In FIG. 2, configuration blocks, which will be described hereinafter, are connected to a system bus 1. A program memory 3 (hereinafter referred to as a “PMEM”) appropriately selects and reads a program of this processing from a disk 10, and a CPU (Central Processing Unit) 2 executes the program. Data input using a keyboard 12 is stored as code information in the PMEM 3 serving as a text memory. A communication controller 4 controls data input/output of a communication port 5. A signal output from the communication port 5 is transmitted through a communication line 6 to a communication port of another apparatus 7 on a network.

Note that, although the network such as the LAN is described in this embodiment, it is apparent that the present invention is also applicable in a case where the communication port 5 which is connected to the communication controller 4 and the communication line 6 are a port and a line of a general public line.

An external-storage-device controller 8 controls access to a disk 9 and the disk 10 which store data files. The disk 9 corresponds to a flexible disc (hereinafter referred to as a “FD”), and the disk 10 corresponds to a hard disk (hereinafter referred to as a “HD”).

An input controller 11 is connected to a keyboard 12 and a pointing device 13 such as a mouse. A user issues an instruction on an operation of the system, for example, by operating the keyboard 12. The pointing device 13 is used to issue an instruction on processing to be performed on image information in a CRT (Cathode Ray Tube) 16. That is, the pointing device 13 is used to arbitrarily move a cursor in the CRT 16 in an X direction or a Y direction, and select a command icon included in a command menu so as to perform instruction on the processing, to specify an object to be edited, and to specify a position of rendering.

A video image memory (hereinafter referred to as a “VRAM”) 14 stores bitmap data to be displayed in the CRT 16 through a display output controller 15. Note that the display device is not limited to the CRT 16 but a liquid crystal display or a plasma display, for example, may be employed.

Note that programs stored in a ROM in this embodiment may be stored in a computer-readable storage medium such as a hard disk (HD) or a flexible disk (FD) which is directly connected to the apparatus.

Alternatively, the programs stored in a ROM in this embodiment may be stored in another apparatus connected through the network. The programs of this embodiment may be supplied to systems and apparatuses by a computer-readable storage medium such as a FD or an HD or a network.

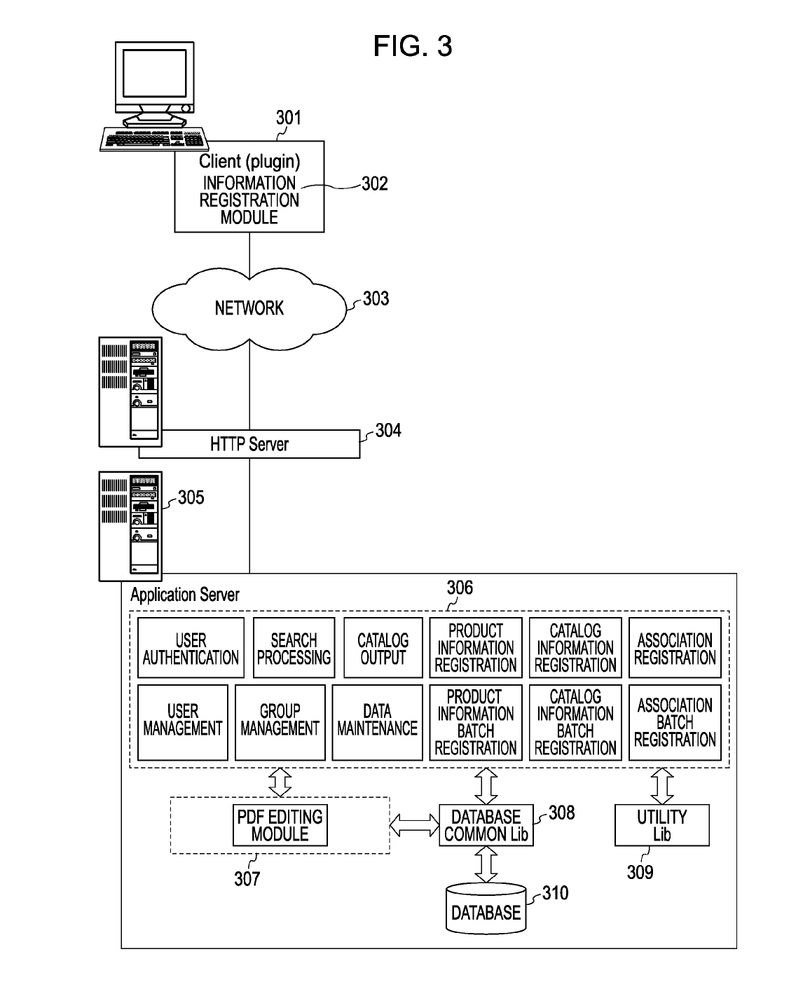

FIG. 3 is a block diagram illustrating a module configuration of the information processing system according to this embodiment.

In FIG. 3, a client PC 301 stores an information registration module 302 used to register data files such as catalog information and image data in the a web application server 305.

Note that the information registration module 302 is automatically delivered by a plug-in form of a Web browser as needed from the web application server 305, and therefore, an installation process is not required in the client PC 301.

A network 303 is used for data communication.

The web application server 305 stores a module 306 used to process a request transmitted from the client PC 301 through a HTTP server 304. The module 306 has a user authentication function, a function of search processing, a function of batch registration of various data items, a function of outputting product information, and a data maintenance function, for example. Such module items included in the module 306 are uploaded to a memory in accordance with a request supplied form the client PC 301 so that operations are performed.

In addition to the module items, the web application server 305 includes a PDF editing module 307 used to perform editing such as image editing performed on PDF files, extraction of text information, combination of PDF files, and to division of PDF files.

Furthermore, the web application server 305 includes a common library (common Lib) 308 used to perform data communication with a database 310 and various utility libraries 309.

Note that the module 306 includes a user authentication module item, a search processing module item, a catalog outputting module item, a product-information registration module item, a catalog-information registration module item, and an association registration module item. The module 306 further includes a user management module item, a group management module item, a data maintenance module item, a product-information batch registration module item, a catalog-information batch registration module item, and an association batch registration module item.

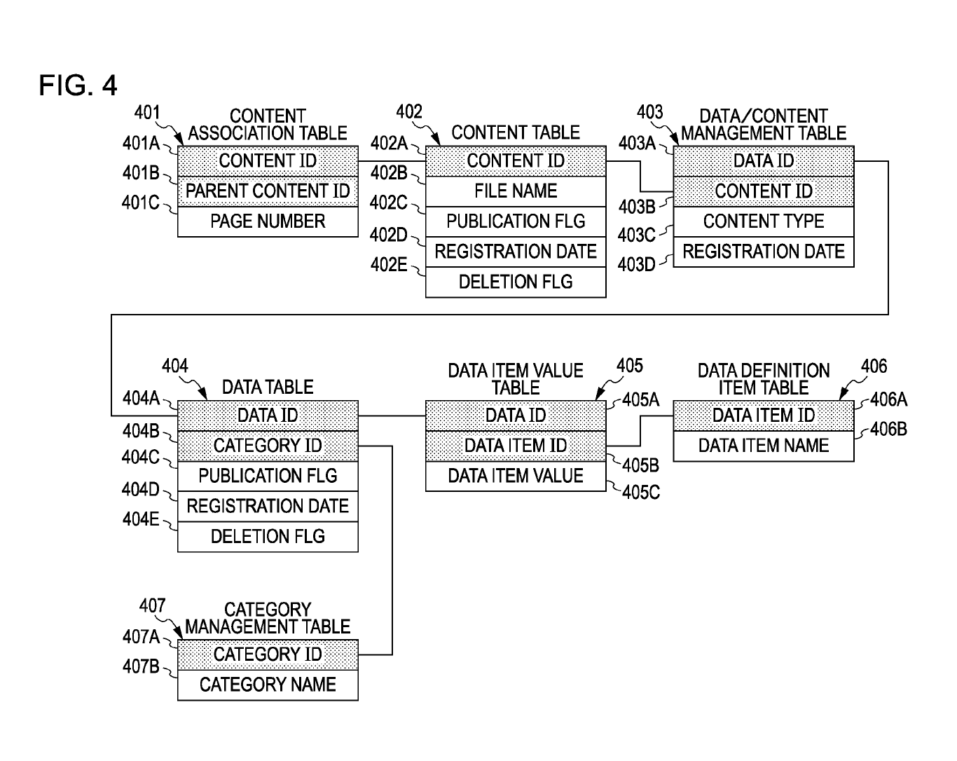

FIG. 4 is a diagram illustrating table information items managed in the database 310 shown in FIG. 3. FIG. 4 shows examples of tables of the database 310 which manages product information and catalog information of this system.

In FIG. 4, a data table 404 manages text information such as product master information. The data table 404 stores a data ID 404A which is uniquely determined, a registration date 404D, an updating date, a publication flag 404C representing whether this information has been published on a web site, and a deletion flag 404E representing whether this information has been deleted. Note that a reference symbol 404B denotes a category ID.

A category management table 407 manages categories in which data items belong. The category management table 407 includes a category ID 407A and a category name 407B.

A content table 402 manages information such as catalog data files. The content table 402 stores, a content ID 402A which is uniquely determined similarly to the data ID 404A of the data table 404, a registration date 402D, a file name 402B, an updating date, a publication flag 402C representing whether this information has been published on a web site, and a deletion flag 402E representing whether this information has been deleted.

A content file having multi-pages is associated with a content-association table 401 which manages information items of the pages. The content-association table 401 includes property information of each page of the content file. Examples of the property information include a content ID 401A assigned for each page, a page number information 401C, and a parent content ID 401B representing an ID of the content file including original multi-pages before the content files are divided into pages.

A data/content management table 403 associates the content file managed by the content table 402 with the text information managed by the data table 404. The content file is subjected to association processing for each content ID 403B, and therefore, the content file is subjected to the association processing for each page.

The data/content management table 403 further includes a content type 403C representing a type of content association, and a registration date 403D. The data/content management table 403 further includes a data ID 403A.

A data-definition item table 406 manages a name of a data-item value table 405 associated with the data table 404. The data-definition item table 406 manages, for example, as items, a data item ID 406A which is an ID of a data item such as product information including a product name or a price, and a data item name 406B.

A data item value table 405 stores a data ID 405A, a data item ID 405B, and a data item value 405C.

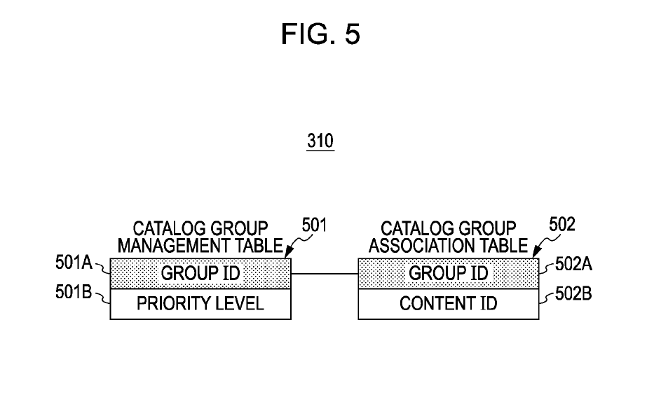

FIG. 5 is a diagram illustrating a grouping management table for a catalog managed in the database 310 of FIG. 3.

In FIG. 5, a catalog-group management table 501 manages group information and a priority level as priority information. The catalog-group management table 501 stores a group ID 501A which is uniquely determined and a priority level 501B.

A catalog-group association table 502 manages catalog data items which belong to certain groups on the basis of content IDs. The catalog-group association table 502 includes a group ID 502A and a content ID 502B.

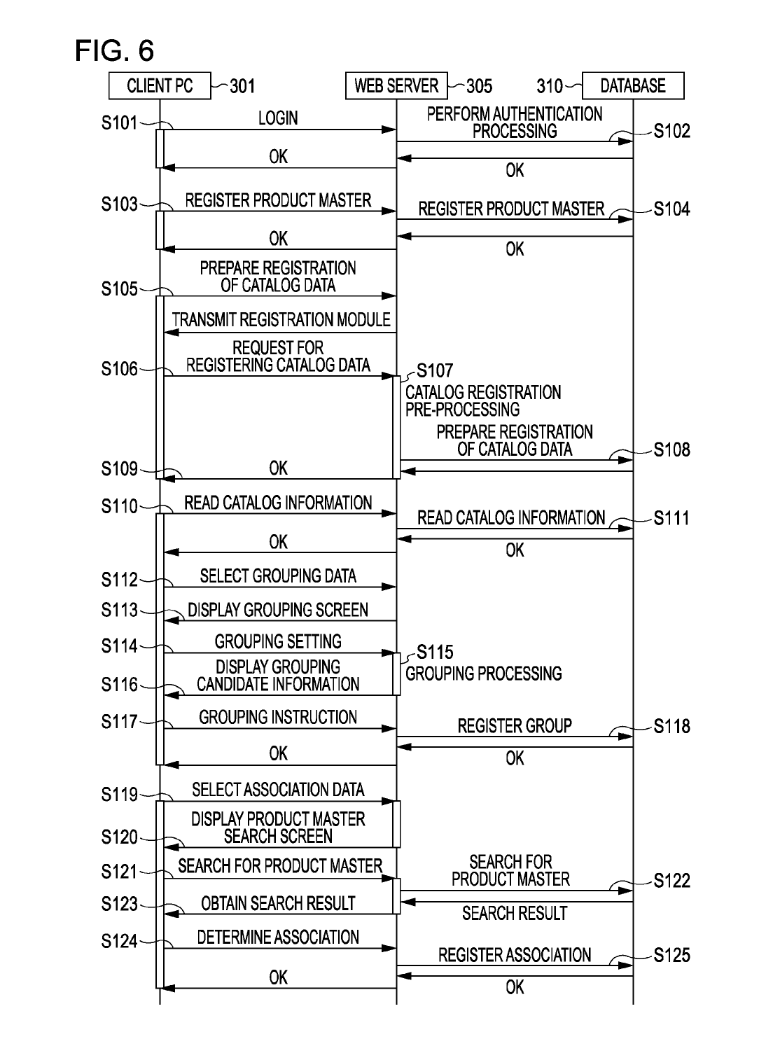

FIG. 6 is a flowchart illustrating an example of a data processing procedure of a data processing system according to this embodiment. This example of the data processing procedure corresponds to catalog-data registration processing. Note that, among step S101 to step S125, step S101, step S103, step S105, step S106, step S110, step S112 to step S114, step S116, step S117, step S119 to step S121, step S123, and step S124 are performed by the client PC 301, and the other steps are performed by the web application server 305. These steps are realized by loading a module into the PMEM 3 from the hard disk 10 and executing the module by the CPU 2 of the client PC 301 or the web application server 305.

In step S101, when a system administrator inputs an account ID and a password using the client PC 301, processing of logging in the web application server 305 is performed. Note that an authentication method is not limited to a method using an account ID and a password.

In response to a request of the login, the CPU 2 of the web application server 305 makes an inquiry to the database 108 as to whether the catalog-data registration processing is allowed to be executed with the input account ID and the input password, in step S102.

When the CPU 2 of the web application server 305 determined that the catalog-data registration processing is not allowed to be performed, the web application server 305 returns a signal to the client PC 301 so that the client PC 301 displays an error screen. This processing is thus terminated.

On the other hand, when the CPU 2 of the web application server 305 determined that the catalog-data registration processing is allowed to be performed with the input account ID and the input password, the process proceeds to step S103. Then, the web application server 305 transmits a signal to the client PC 301 so that the client PC 301 displays a catalog-data registration screen, in step S103.

Note that the catalog-data registration screen for the system administrator, for example, is displayed in the CRT 16 of the client PC 301.

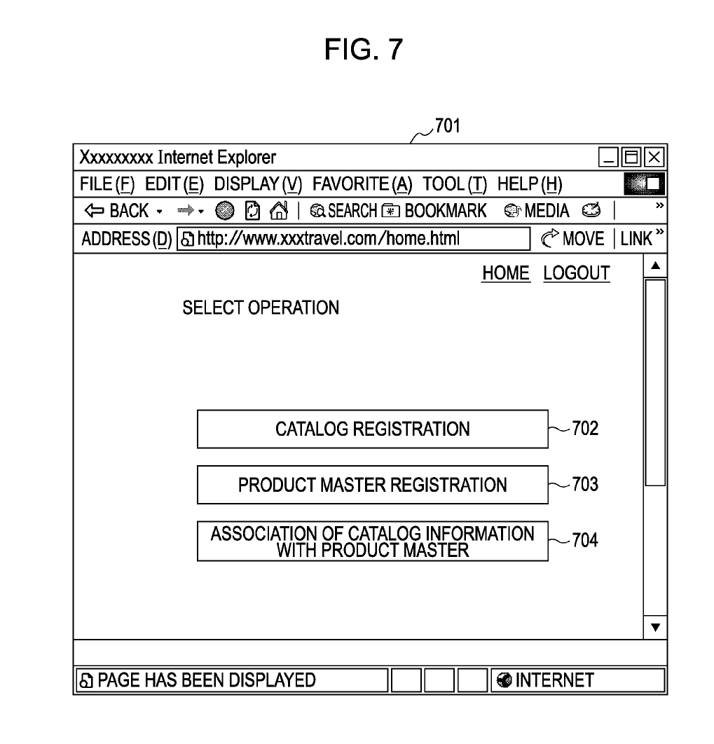

FIG. 7 is a diagram illustrating an example of a catalog-registration-function list screen 701 displayed in the client PC 301 shown in FIG. 3.

In FIG. 7, a catalog registration button 702 is used to select catalog data items to be registered in the web application server 305 so that the registration processing is executed.

A product-master registration button 703 is used to register product master data items in the web application server 305. A catalog-information-and-product-master association button 704 is used to associate catalog data items registered in the web application server 305 with product master data items.

After receiving a request for registration of a product master from the client PC 301 in step S103, the CPU 2 of the web application server 305 registers a product master in the database 108 in step S104.

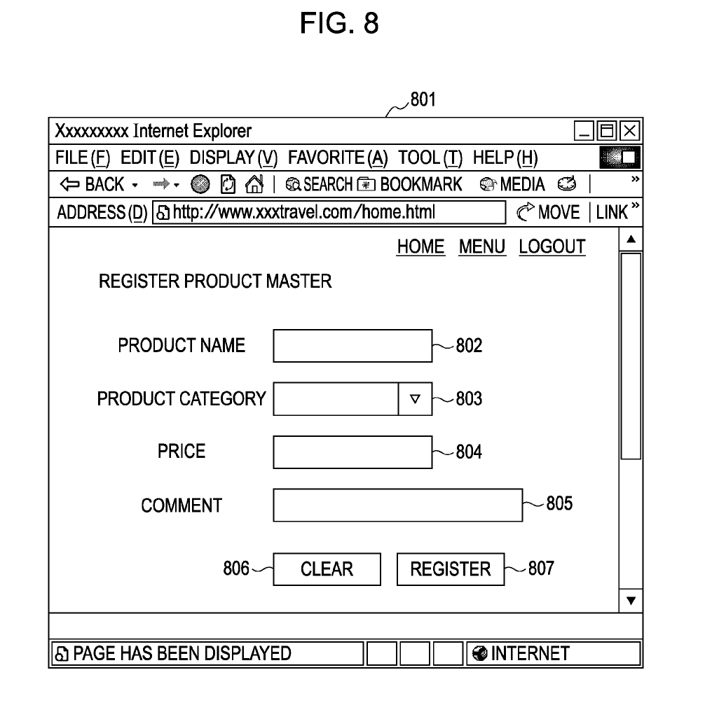

FIG. 8 is a diagram illustrating an example of a product-master registration screen 801 displayed in the client PC 301 of FIG. 3.

In FIG. 8, in the product-master registration screen 801 used to set a product master, a product name 802, a product category 803, a product price 804, and information on other comments 805 are set as setting items. When a clear button 806 is selected, all information items which have been input are cleared. In this example, in addition to the setting items described above which can be registered as product masters, other items may be added.

When the user selects a registration button 807, input information on a product master is registered in the database 310.

The operation of registering the product master to the database 310 is thus completed.

Then, the process proceeds to step S105 in order to perform processing of registering catalog data.

In step S105, the client PC 301 prepares a registration of catalog data to the web application server 305. The web application server 305 transmits a file registration module to the client PC 301. In a case where another file registration module has already been included in the client PC 301, the file registration module is not transmitted from the web application server 305.

In step S106, the system administrator selects catalog data to be registered, and instructs the web application server 305 to perform registration of the catalog data.

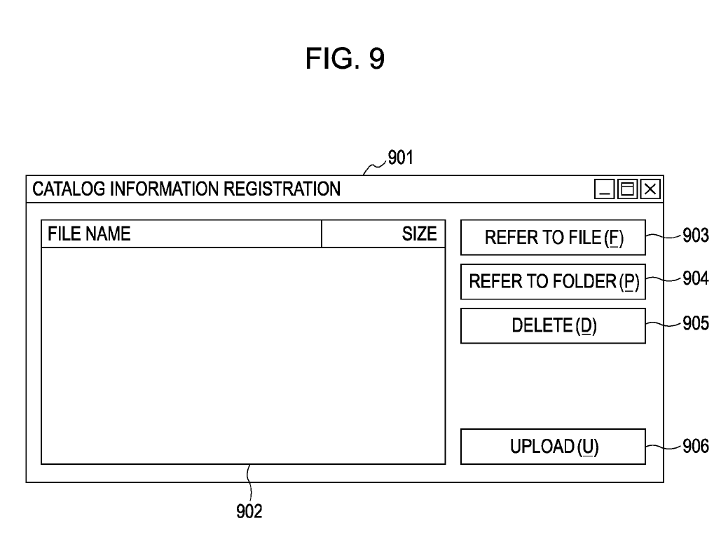

FIG. 9 is a diagram illustrating an example of a catalog registration screen 901 which is used to select catalog data to be registered and which is displayed in the client PC of FIG. 3. The file registration module transmitted from the web application server 305 to the browser of the client PC 301 is used to display the catalog registration screen 901.

In FIG. 9, a file list 902 displays a list of files to be registered in the web application server 305.

When a file-reference button 903 is pressed, a file-reference screen used to select a file to be registered is displayed. When the administrator selects the file reference button 903, the screen used to refer to files is displayed. Then, certain files are selected, for example, all the selected files are displayed in the file list 902.

When a folder-reference button 904 is selected, a screen used to refer to folders is displayed. Then, a certain folder is selected, all files included in the selected folder are displayed in the file list 902.

When a file to be deleted is selected from files in the file list 902 and the administrator selects a delete button 905, the file is deleted from the file list 902.

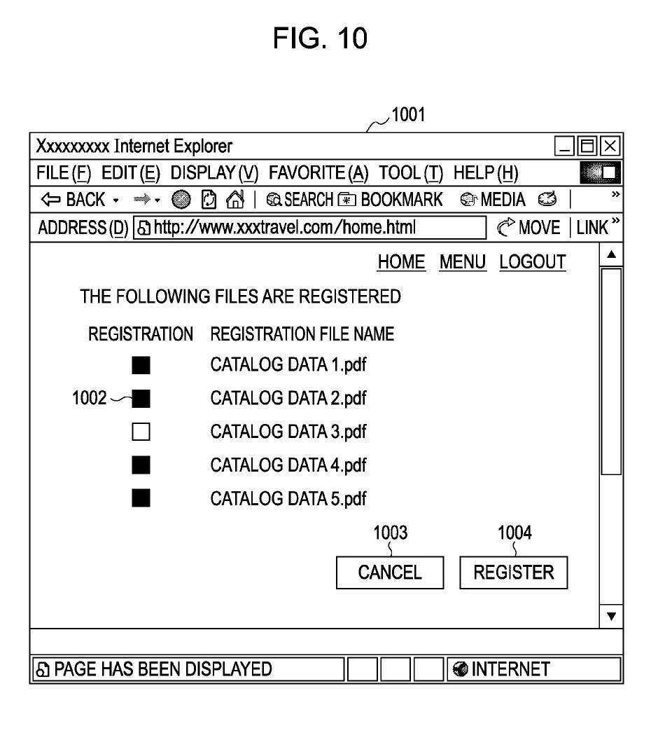

An upload button 906 is used to perform processing of registering all files displayed in the file list 902 to the server 305. When the upload button 906 is selected, a registration confirmation screen is displayed as shown in FIG. 10.

FIG. 10 is a diagram illustrating an example of a confirmation screen 1001 which is used to confirm data files to be registered and which is displayed in the client PC of FIG. 3. In this example, data files registered in the database 310 by the web application server 305 are displayed.

When the administrator unchecks certain checkboxes located at beginnings of file names in a file list 1002, files corresponding to the file names in which the checkboxes thereof have been unchecked are excepted from files to be registered in the server. In this example, a file “catalogdata3.pdf” is not registered in the web application server 305.

When the administrator selects a cancel button 1003, the processing of registering files to the web application server 305 is canceled. When the administrator selects a registration button 1004, the web application server 305 registers selected files to the database 310. Referring back to the flowchart of FIG. 6, the description is continued hereinafter.

In step S107, the web application server 305 which has received the registration request performs preprocessing for registration of catalog data to the database 310. Note that, in this preprocessing, the web application server 305 divides a catalog data file to be registered for individual pages so as to generate files corresponding to the individual pages. Note that the different files have different names each of which is constituted by an original file name and a corresponding page number of five digits. However, a rule of the file names is not limited to this.

Furthermore, the web application server 305 generates thumbnail images corresponding to the catalog data and the generated files.

In step S108, the web application server 305 performs processing of registering a result of the preprocessing to the database 310 as catalog data. Here, as for the file which has been divided into pages, the web application server 305 registers all the files obtained by dividing the original file into pages to the database 310 along with the original file.

Furthermore, thumbnail image files corresponding to the thumbnail images are registered in the database 310. After the preparation of the registration to the database 310 is appropriately terminated, the web application server 305 transmits a signal representing a screen representing normal termination to the database 310 which has been operated by the administrator, for example, in step S109. The registration of the catalog data to the database 310 is thus terminated.

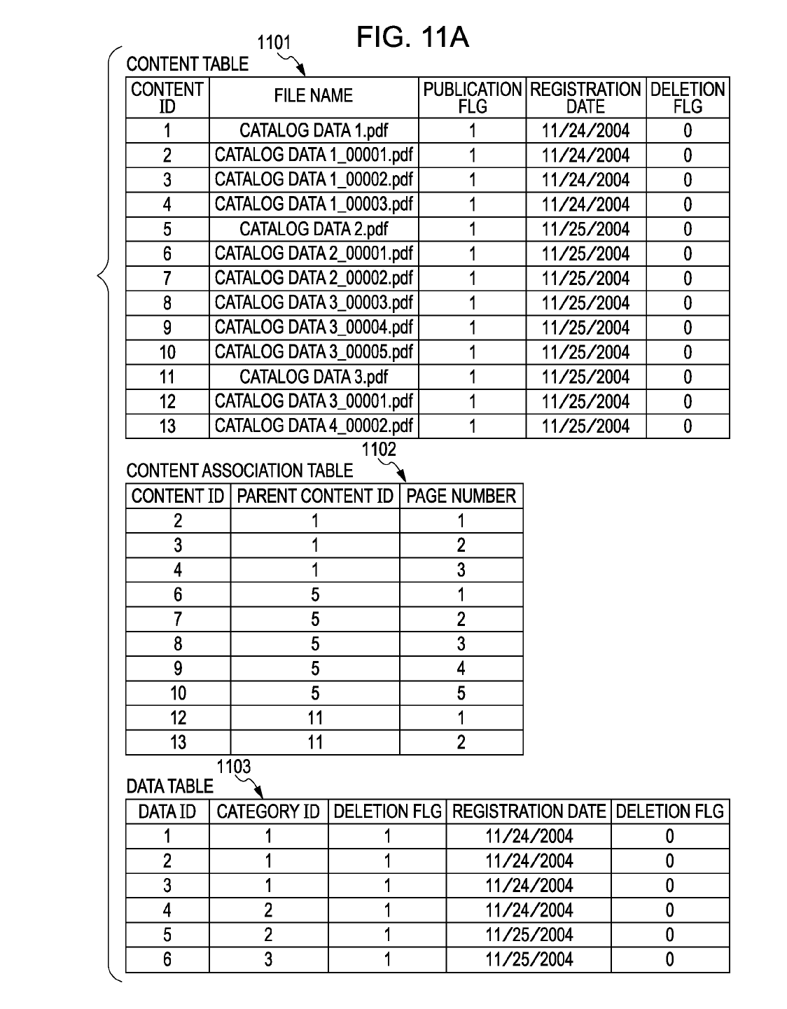

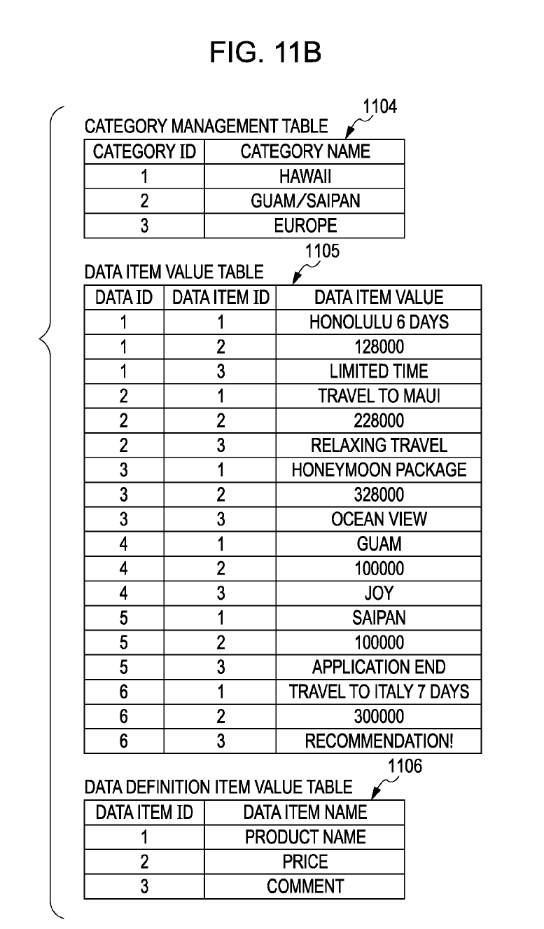

FIGS. 11A and 11B are diagrams illustrating tables registered in the database 310 shown in FIG. 3. In this example, the tables are included in the database 310, and the registration of product masters and the registration of catalog data items to the database 310 have been completed through the processing shown in FIG. 6.

In FIGS. 11A and 11B, in a content table 1101 which manages registered catalog data, a registered original catalog data file and catalog data files obtained by dividing the original catalog data file are managed by sequential content IDs assigned thereto. Note that, in this example, the content table 1101 includes the content IDs, file names, publication flags (publication FLGs), registration dates, and deletion FLGs.

In a content association table 1102, the parent-child relationships of catalogs are managed. Pages obtained by dividing the original catalog data file are associated with the content ID of the original catalog data file, serving as a parent content ID. Furthermore, the content association table 1102 includes information on page numbers of the pages in the original catalog data file. In this embodiment, the content association table 1102 includes the content IDs, the parent IDs, and the page numbers.

In a data table 1103 in which product master data items are managed, sequential data IDs are assigned to the individual product master data items. Furthermore, the product master data items are associated with IDs of categories to which product masters corresponding to the product master data items belong. In this example, the data table 1103 includes the data IDs, the category IDs, publication FLGs, registration dates, and deletion FLGs.

In a category management table 1104, category IDs are assigned to product categories to be managed. In this example, the category management table 1104 includes the category IDs and category names.

A data-item value table 1105 stores data-item values and is used to manage the actual data-item values of the product master data items. Furthermore, the data-item values are associated with the product master data items by corresponding data IDs, and moreover, associated with a data-definition-item-value table 1106 by data-item IDs. In this example, the data-item value table 1105 includes the data IDs, the data-item IDs, and the data-item values.

In the data-definition-item-value table 1106, data-item names are managed. In this example, sequential data-item IDs are assigned to the data-item names to be managed. In this example, the data-definition-item-value table 1106 in which the data-item names corresponding to data definition items are managed includes the data-item IDs and the data-item names.

Then, in step S110 of FIG. 6 onwards, grouping of catalog data items and processing of associating product masters with the catalog data items are performed.

In step S110, the client PC 301 instructs the web application server 305 to read catalog data items which have been subjected to the registration processing from the database 310. In accordance with the instruction, the web application server 305 reads the catalog data items which have not yet been associated with product masters from the database 310 in step S111, and transmits the read catalog data items to the client PC 301 which is operated by the administrator. Then, process proceeds to step S112 where the client PC 301 performs grouping.

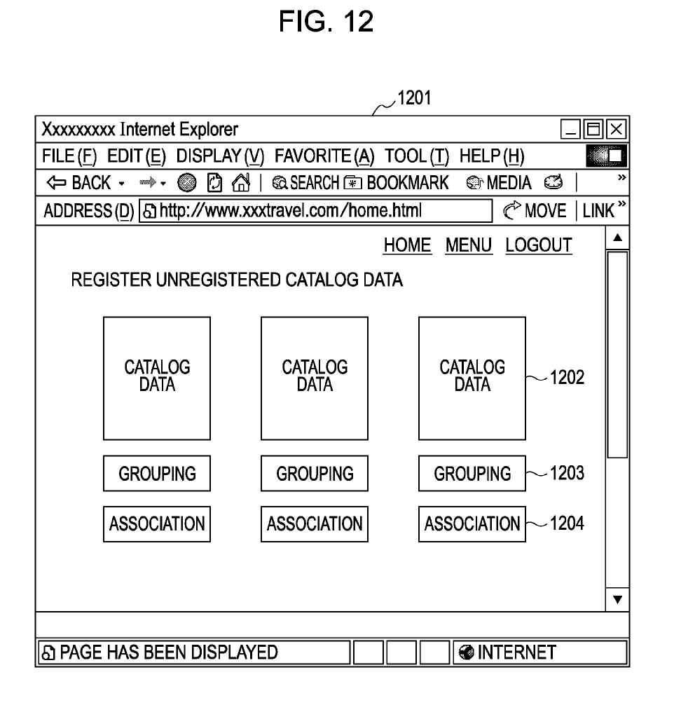

FIG. 12 is a diagram illustrating an example of a catalog-data processing screen displayed in the client PC 301 of FIG. 3. In this example of the screen, catalog data items which have not associated with product masters included in the web application server 305 are confirmed and selected.

In FIG. 12, a reference numeral 1201 denotes a confirmation screen, and a reference numeral 1202 denotes a list of the catalog data items which have not associated with product masters included in the web application server 305. When a grouping button 1203 is selected, grouping of the selected catalog data items is started. When an association button 1204 is selected, association processing is performed on the selected catalog data items.

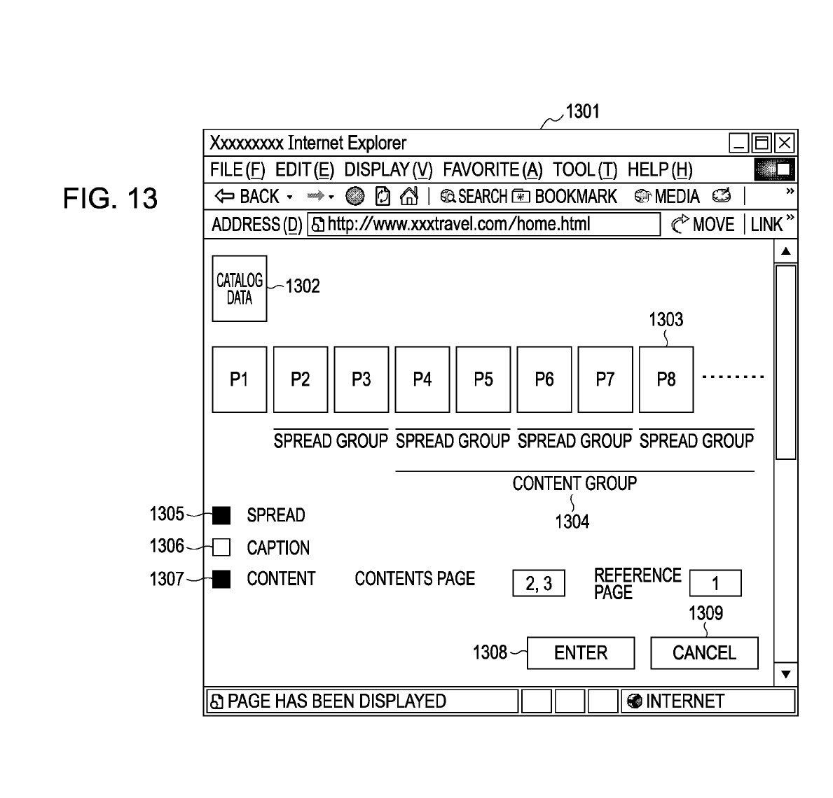

In step S112, when the administrator selects one of the catalog data items using the confirmation screen 1201 of FIG. 12, the client PC 301 transmits a request for grouping to the web application server 305. In step S113, the web application server 305, which has received the request from the client PC 301, displays a grouping screen shown in FIG. 13 used to perform grouping.

In step S114, the client PC 301 transmits information on grouping setting to the web application server 305. In step S115, the web application server 305 analyzes the selected catalog data item and generates group information items unique to properties in accordance with the setting whereby the grouping processing is performed. In step S116, results of the grouping processing are transmitted to the client PC 301. In step S117, determination of the grouping is transmitted to the web application server 305. In step S118, the web application server 305 registers the group information items in the database 310. Note that, different properties such as a spread property, a content property, and a caption property are used in the processing of generating groups of this embodiment, and the grouping processing is performed in accordance with the properties as described below.

FIG. 13 is a diagram illustrating an example of a catalog-data grouping screen 1301 displayed in the client PC 301 of FIG. 3.

In FIG. 13, a reference numeral 1302 denotes a thumbnail of the selected catalog data item, a reference numeral 1303 denotes thumbnails of pages obtained by dividing the selected catalog data item.

Information on a content group 1304 is generated in response to an instruction on grouping. Any method may be employed as a method for displaying the content-group information 1304 as long as the pages which have been subjected to the grouping and a grouping method are recognized.

When a checkbox 1305 which is used to determine whether setting of spread grouping is performed is checked, the spread grouping is executed.

When a checkbox 1306 which is used to determine whether setting of caption grouping is performed is checked, the caption grouping is executed. When a checkbox 1307 which is used to determine whether setting of content grouping is performed is checked, the content grouping is executed. Here, a content page including content and a reference page which is used to specify a page of an actual catalog corresponding to the first page of the content should be determined.

Note that after the grouping is executed, results of the grouping are reflected in the content-group 1304. When an “enter” button 1308 is selected, the grouping is set.

When a cancel button 1309 is selected, the setting of grouping is cancelled.

In the group setting, different values are set, in accordance with various grouping methods, as initial values of priority levels held along with group information items.

For example, a priority level for the spread grouping is set to “10”, a priority level for the caption grouping is set to “5”, and a priority level for the content grouping is set to “20”. In this way, the content grouping is determined to be highly reliable in initial setting, and a high priority level is set to the content grouping.

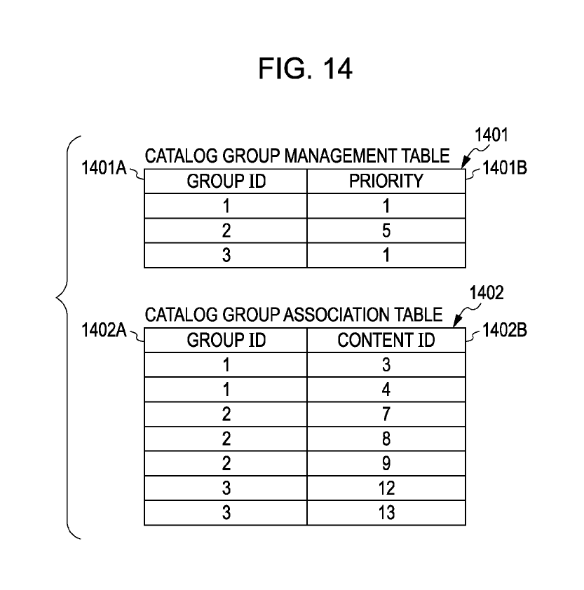

FIG. 14 shows examples of tables managed by the database 310 of FIG. 3. These examples correspond to content of the database 310 after the group registration of the catalog data item is terminated.

In FIG. 14, a catalog-group management table 1401 is used to manage group information items and priority levels of a catalog. Sequential group IDs 1401A are assigned to groups set to the registered catalog, and are recorded along with priority levels 1401B of the groups.

A catalog-group association table 1402 is used to manage catalog data items which belong to the groups, in accordance with the content IDs. The relationships between group IDs 1402A and content ID 1402B are recorded in the catalog-group association table 1402. In this example, three groups are shown. For example, a group corresponding to a group ID of 2 has a priority level of “5” and includes data items corresponding to content IDs of 7, 8, and 9.

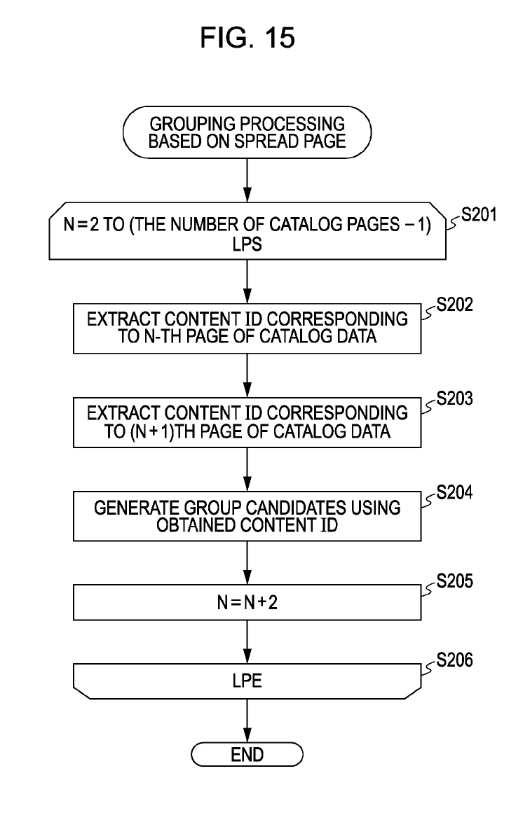

FIG. 15 is a diagram illustrating an example of a data processing procedure of the information processing apparatus according to this embodiment. This example shows spread-grouping processing of FIG. 13 in detail. Step S201 to step S206 are realized by loading a module from the hard disk 10 to the PMEM 3 and executing the module by the CPU 2 of the web application server 305.

A loop from “LPS” of step S201 to “LPE” of step S206 is performed on pages included in a catalog which are subjected to grouping by the CPU 2 of the web application server 305, and is performed during N=2 to N=(the number of catalog pages−1), where N denotes a page number.

In step S202, the CPU 2 extracts a content ID of catalog data which is obtained by dividing the catalog into pages and which corresponds to the N-th page of the catalog. In step S203, the CPU 2 extracts a content ID of catalog data which is obtained by dividing the catalog into pages and which corresponds to the (N+1)th page of the catalog. In step S204, the CPU 2 generates information on a group candidate using the content IDs obtained in step S202 and step S203.

In step S205, N is incremented by 2. In step S206, the loop performed during N=2 to N=(the number of catalog pages−1) is terminated, and the spread grouping processing is thus terminated.

By performing the processing described above, groups of spread pages such as the second and third pages, and the fourth and fifth pages are generated.

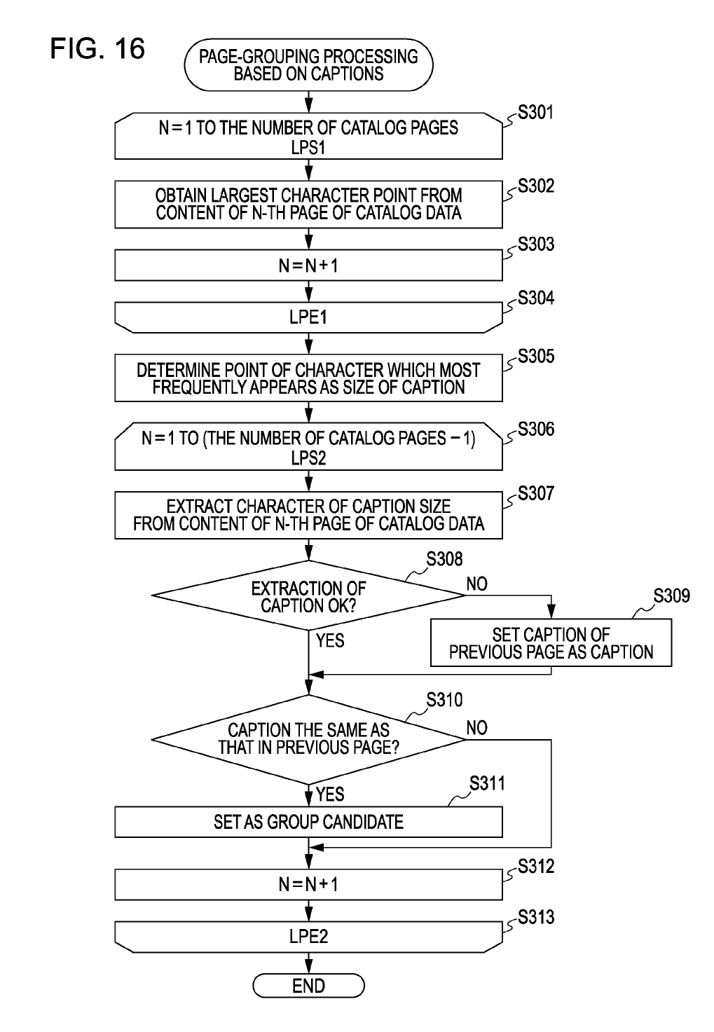

FIG. 16 is a flowchart illustrating an example of another data processing procedure of the information processing apparatus according to this embodiment. This example shows the caption grouping processing shown in FIG. 13. Step S301 to step S313 are realized by loading a module from the hard disk 10 to the PMEM 3 and executing the module by the CPU 2 of the web application server 305.

A loop from “LPS1” of step S301 to “LPE1” of step S304 is performed during N=1 to N=(the number of catalog pages). In step S302, the CPU 2 obtains the largest character point from content corresponding to catalog data of the N-th page. The character point is generally obtained by a method utilizing character property information of a structured document such as a PDF.

Alternatively, the character point may be obtained by a method utilizing an OCR (Optical Character Recognition), and any other methods may be used.

In step S303, the CPU 2 increments N by 1. When it is determined that the number of catalog pages is reached, the loop from LPS1 to LPE1 is terminated and the process proceeds to step S305.

In step S305, among character points obtained while the loop from LPS1 to LPE1 is performed, a character point which the most frequently appeared is determined as a size of a caption.

Then, a loop from LPS2 of step S306 to LPE2 of step S313 is performed on pages included in the catalog which are subjected to grouping during N=1 to N=(the number of catalog pages). In step S307, the CPU 2 extracts a character having the size of a caption as the caption from the content corresponding to the N-th page of the catalog data.

In step S308, the CPU 2 determines whether the caption has been extracted. When the determination is negative, a caption of a preceding page is set as the caption in step S309.

On the other hand, when the determination is affirmative in step S308, the process proceeds to step S310 where the caption of the preceding page and the caption of the current page are compared with each other so that the CPU 2 determines whether the captions are identical in step S310. When the determination is affirmative, it is determined that the preceding page and the current page are candidates of a group in step S311. In step S312, N is incremented by 1. When the number of catalog pages is reached, the loop from LPS2 to LPE2 is terminated in step S313, and this processing is thus terminated.

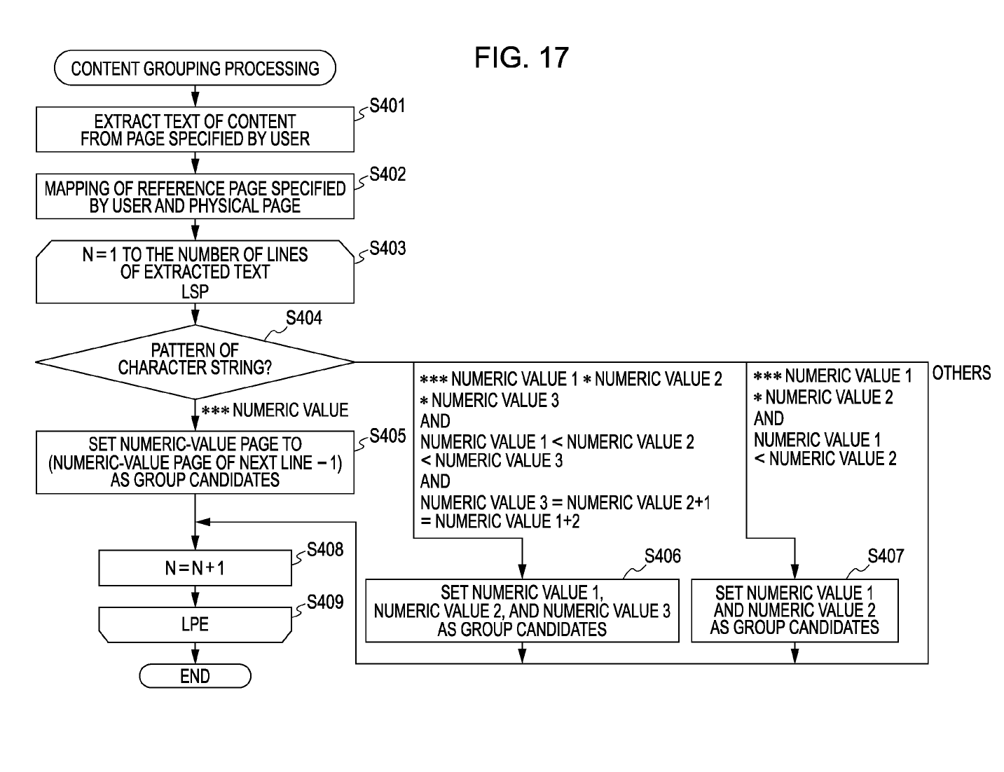

FIG. 17 is a flowchart illustrating an example of a still another data processing procedure of the information processing apparatus according to this embodiment. This example shows the content-grouping processing of FIG. 13.

Step S401 to step S409 are realized by loading a module from the hard disk 10 to the PMEM 3 and executing the module by the CPU 2 of the web application server 305.

In step S401, text corresponding to content is extracted from a page specified by the user. Note that the user can specify a single page or a plurality of pages. In step S402, a reference page specified by the user and a physical page are mapped to each other. By this, a page of a physical electronic data file corresponding to the first page of the catalog which is determined as the first page in the content is determined.

A loop from LPS of step S403 to LPE of step S409 is performed by the CPU 2 during N=1 to N=(the number of lines of the extracted text). In step S404, the CPU 2 discriminates a type of a character-string pattern of the N-th line. When the CPU 2 determined that the character-string pattern is “***numeric value” in step S404, a page corresponding to the numeric value to a page corresponding to ((a numeric value of a character string of “***numeric value” in the (N+1)th line)−1) are determined as candidates of grouping in step S405.

Note that the page corresponding to the numeric value is converted into the physical page which has been mapped in step S402, and thereafter, is mapped to a content ID of a corresponding page of the catalog which has been subjected to the grouping.

On the other hand, when the CPU 2 determined that the character-string pattern is “***(numeric value 1)*(numeric value 2)*(numeric value 3)” and expressions (numeric value 1)<(numeric value 2)<(numeric value 3) and (numeric value 3)=(numeric value 2)+1=(numeric value 1)+2 are satisfied in step S404, the pages corresponding to numeric value 1, numeric value 2, and numeric value 3 are determined to be the candidates of the grouping in step S406.

Similarly, when the CPU 2 determined that the character-string pattern is “***(numeric value 1)*(numeric value 2)” and an expression (numeric value 1)<(numeric value 2) is satisfied in step S404, the pages corresponding to numeric value 1 and numeric value 2 are determined to be the candidates of the grouping in step S407. Then, in step S408, N is incremented by 1. When the CPU 2 determined that N reached the number of lines of the extracted text, the loop is terminated in LPE of step S409. This processing is thus terminated.

Referring back to FIG. 6, the processing from step S119 onwards will be described.

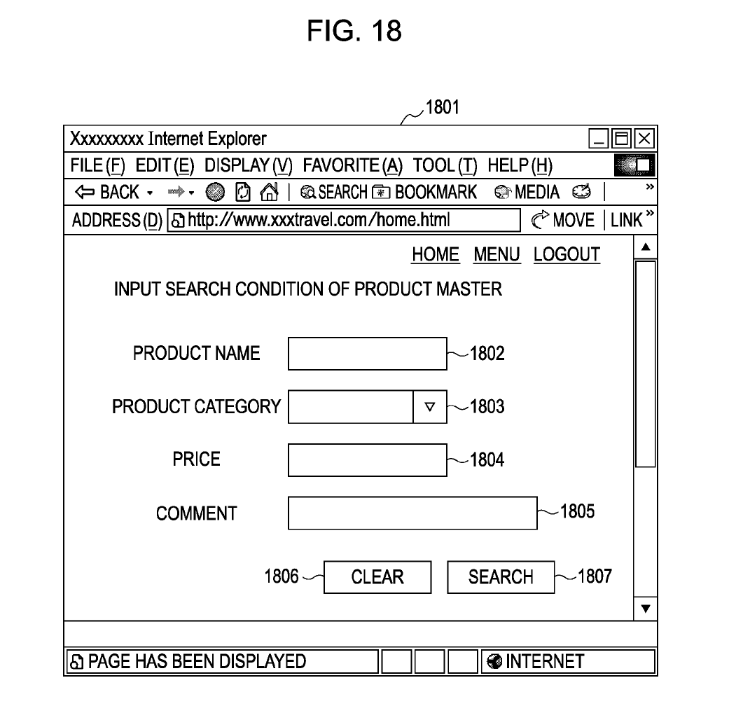

In step S119, the client PC 301 transmits a request for association processing to the web application server 305. In step S120, in response to the request, the web application server 305 transmits a signal corresponding to a product-master search screen 1801 to the client PC 301 so that product masters to be subjected to the association processing is to be selected. Then, the product-master search screen 1801 is displayed in the CRT 16 of the client PC 301 as shown in FIG. 18.

FIG. 18 is a diagram illustrating an example of the product-master search screen 1801 displayed in the client PC 301 of FIG. 3.

The product-master search screen 1801 of FIG. 18 includes a product name 1802, a product category 1803, a product price 1804, and other comment information 1805. When a clear button 1806 is selected, all input information items are cleared. When a search button 1807 is selected, product masters corresponding to the input search condition are searched for. Note that the product name 1802 to the comment information 1805 correspond to search items registered in the database 310.

In step S121, the client PC 301 transmits the search condition to the web application server 305. The web application server 305 searches the database 310 for the product masters in step S122, and transmits results of the searching to the client PC 301 in step S123.

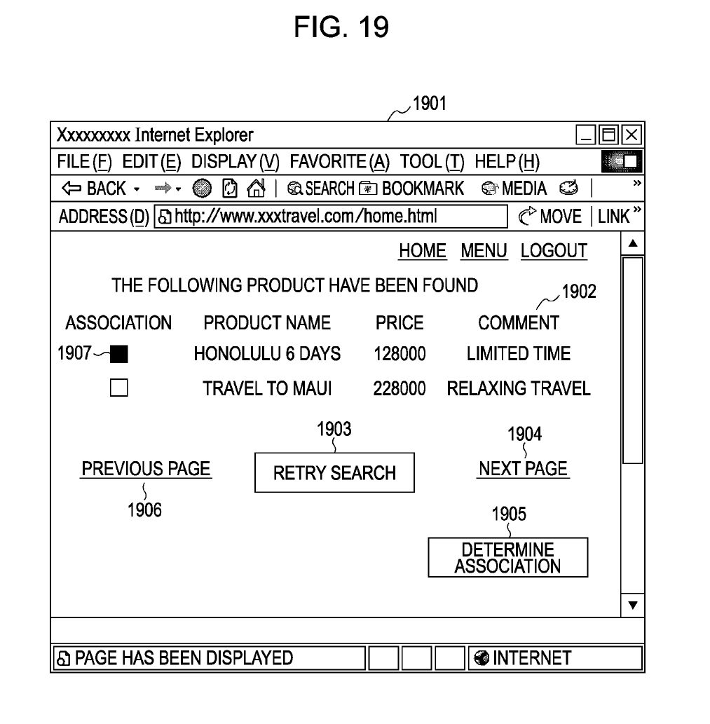

FIG. 19 is a diagram illustrating an example of a product-master search-result screen 1901 displayed in the client PC 301 of FIG. 3.

In a list 1902 of the results of the searching, information items of product masters which have been retrieved are displayed. When a search-retry button 1903 is selected, the product-master search screen 1801 of FIG. 18 is displayed again. Note that, in this example, two master information items are displayed, and display of the results of the searching is changed by selecting a previous-page button 1906 or a next-page button 1904. When an association-determination button 1905 is selected, one of the information items in which an association checkbox 1907 thereof is checked is associated with the catalog data. Here, in step S124 of FIG. 6, the web application server 305 is notified of the product master to be associated, and in step S125, the web application server 305 registers association information in the database 310. The series of catalog registration processing is thus terminated.

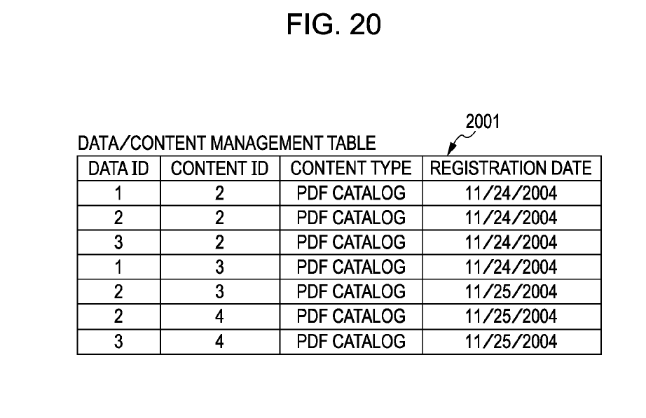

FIG. 20 is a diagram illustrating an example of a data/content management table 2001 managed by the database 310 of FIG. 3. This example shows the data/content management table 2001 when the catalog and the product masters are associated with each other. In this example, catalog-page data having a content ID of “2” is associated with product masters having data IDs of “1” to “3” by a content type of “PDF catalog”. Similarly, catalog-page data having a content ID of “3” is associated with product masters having data IDs of “1” and “2” by the content type of “PDF catalog”. Furthermore, catalog-page data having a content ID of “4” is associated with product masters having data IDs of “2” and “3” by the content type of “PDF catalog”.

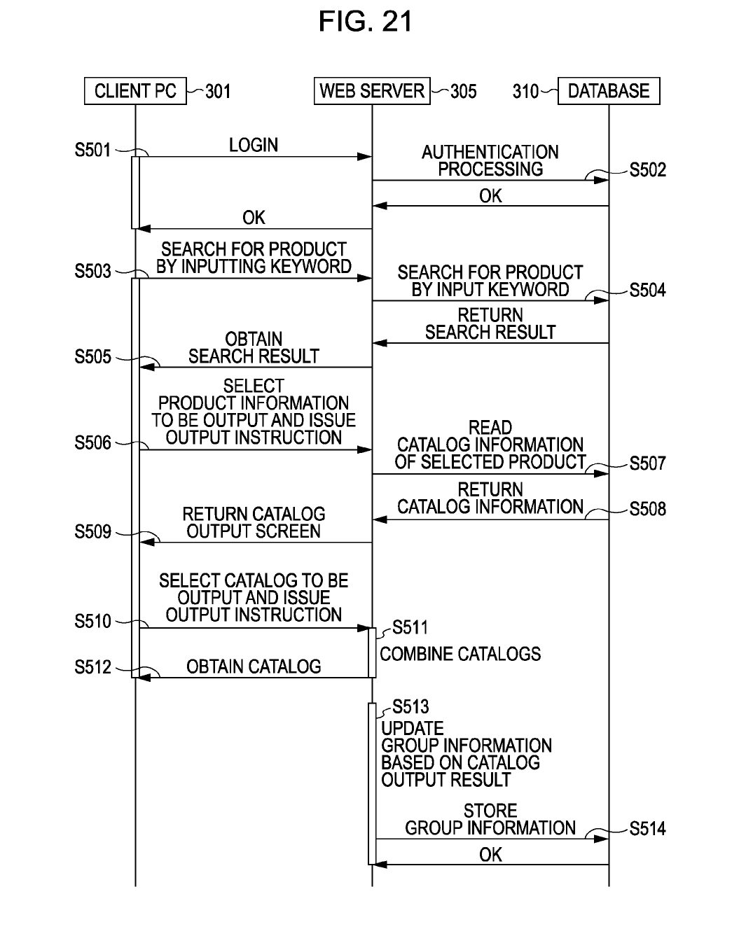

FIG. 21 is a flowchart illustrating data processing performed by the data processing system included in the information processing system according to this embodiment. This example shows an example of catalog-data output processing performed by the client PC 301, the web application server 305, and the database 310.

Note that, among step S501 to step S514, step S501, step S503, step S505, step S506, step S509, step S510, and step S512 are executed by the CPU 2 of the client PC 301, and the other steps are executed by the CPU 2 of the web application server 305.

In step S501, the user makes a request for logging in the web application server 305 through the client PC 301 using an account ID and a password. Note that an authentication method is not limited to a method using an account ID and a password.

In response to the request, the web application server 305 makes an inquiry to the database 310 about whether the user is allowed to use the system using the input account ID and the input password whereby authentication processing is performed in step S502. When the CPU 2 of the web application server 305 determined that the user is not allowed to use the system, a signal corresponding to an error screen is transmitted to the client PC 301 operated by the user.

On the other hand, when the CPU 2 of the web application server 305 determined that the user is allowed to use the system, the process proceeds to step S503.

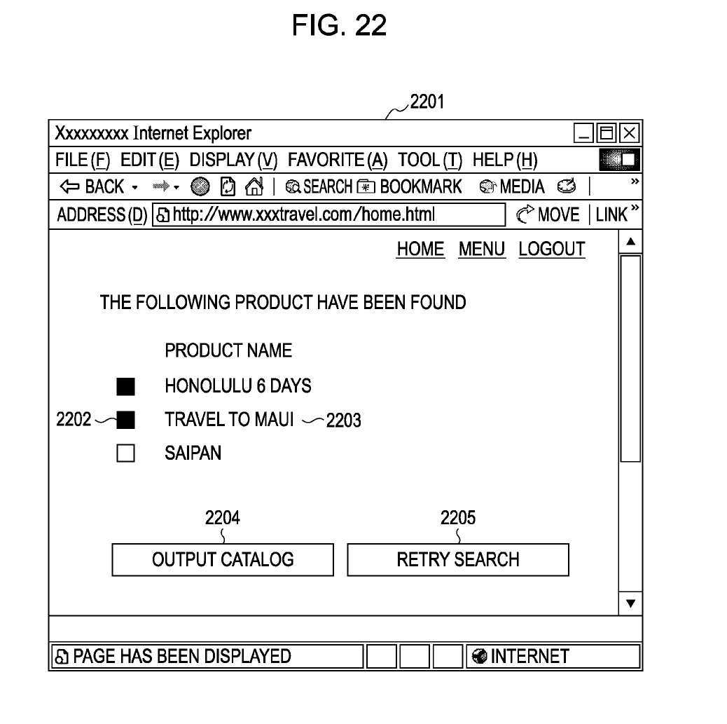

In step S503, the user inputs a keyword so as to search for product data items. In response to the input keyword, the web application server 305 searches the database 310 for product data items corresponding to the input keyword in step S504, and transmits results of the searching as a list of the product data items to the client PC 301 operated by the user. In step S505, the user obtains the results of the product searching to be displayed in a product-search-result screen 2201 of FIG. 22.

FIG. 22 is a diagram illustrating an example of the results of the product searching displayed by the information processing apparatus according to this embodiment.

In FIG. 22, a reference numeral 2203 denotes simple information items. When a desired product to be output is selected using checkboxes 2202 and a catalog-output button 2204 is selected, a catalog-output screen which displays a catalog associated with the selected product is displayed. When a search-retry button 2205 is selected, the product-master search screen 1801 is displayed again, and the searching may be performed again.

In step S506, the user operates the client PC 301 so as to instruct the web application server 305 to output a selected product information item. In accordance with the instruction, the web application server 305 reads catalog information associated with a product corresponding to the selected product information item from the database 310 in step S507.

In step S508, the web application server 305 obtains the catalog information from the database 310. In step S509, the web application server 305 transmits a signal representing the product-search-result screen 2201 serving as a catalog-output screen 2201 shown in FIG. 22 to the client PC 301 operated by the user.

In step S510, the user instructs the web application server 305 to select and output desired catalog pages using the catalog-output screen 2201 of FIG. 22. In step S511, the web application server 305 performs processing of combining catalog page data items on the basis of results of the selection. In step S512, the client PC 301 obtains a catalog including the selected pages which have been combined with each other.

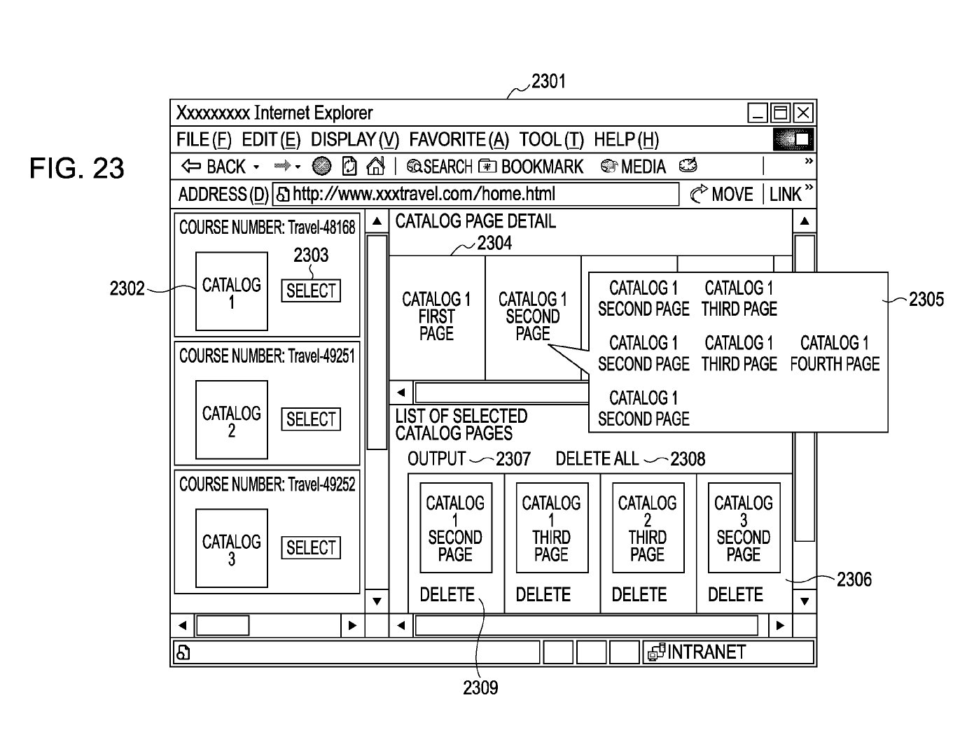

FIG. 23 is a diagram illustrating an example of an output-catalog selection screen 2301 displayed in the information processing apparatus according to this embodiment. In this example, the output-catalog selection screen 2301 is displayed in the CRT 16 of the client PC 301, and a desired catalog to be output is selected from among the catalog data items registered in the database 310 in accordance with a selection operation performed by the user.

In the output-catalog selection screen 2301 of FIG. 23, thumbnails 2302 of the first pages of the catalogs associated with the selected product are displayed. A desired catalog is selected by selecting one of selection buttons 2303. When the desired catalog is selected, all pages of the catalog are displayed as thumbnails 2304.

An output-candidate list 2305 is displayed when a desired one of the thumbnails 2304 which is to be output is selected.

Groups of output candidates are displayed in the output-candidate list 2305 in an order of priority levels of the groups on the basis of information items of the groups which include data of the selected catalog page. Furthermore, the user can select a catalog to be output from the groups in the list 2305.

A reference numeral 2306 denotes thumbnails of catalog information items to be output. When an output button 2307 is selected, a catalog is output. When all-deletion button 2308 is selected, all the information items of the catalogs are cleared. When one of deletion buttons 2309 is selected, an information item of a selected page of a corresponding catalog to be output is cleared.

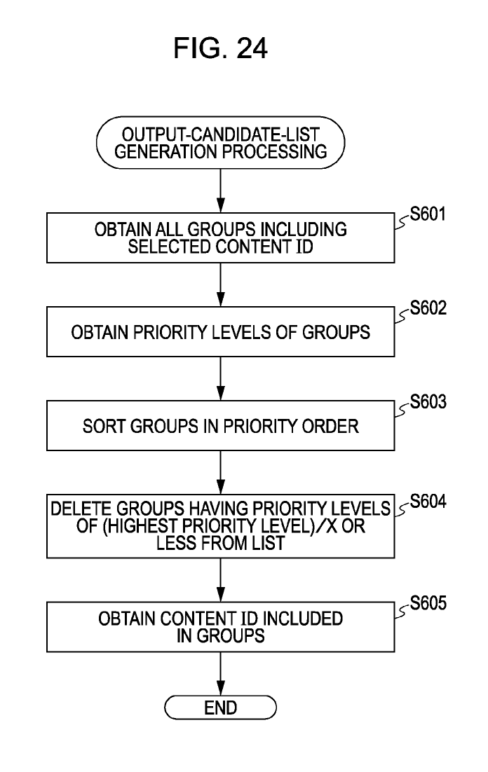

FIG. 24 is a flowchart illustrating a further data processing procedure of the information processing apparatus according to this embodiment. This example shows processing of generating the output-candidate list 2305 performed by the web application server 305. Step S601 to step S605 are realized by loading the module 306 to the PMEM 3 and executing the module 306 by the CPU 2 of the web application server 305.

In step S601, the web application server 305 extracts groups including a content ID of catalog page data including a selected thumbnail from the catalog-group association table 502. In step S602, the web application server 305 obtains priority levels of the groups from the catalog-group management table 501. In step S603, the web application server 305 sorts the groups in accordance with the priority levels.

In step S604, the web application server 305 deletes, among the selected groups, groups having priority levels equal to or lower than (the highest priority level in the listed groups)/X, where X denotes a threshold value. That is, catalog data items which belong to groups having low priority levels are not included in results of the searching.

Note that the threshold value X is set to an arbitrary value in advance. For example, in a case where the threshold value X is set to 10 and the highest priority level in the listed groups is 50, groups having priority levels of 5(50/10) or lower are not listed. Accordingly, since groups which are merely used are not displayed in the list, the number of candidates to be listed is prevented from being unnecessarily increased. Consequently, burden of user's operations is reduced.

In step S605, the web application server 305 obtains the content ID included in the groups, generates data items to be displayed in the list. This processing is thus terminated.

Referring back to FIG. 21, in step S513, the web application server 305 updates group information items in accordance with the output results of the catalog. In step S514, the updated group information items are stored in the database 310. This processing is thus terminated.

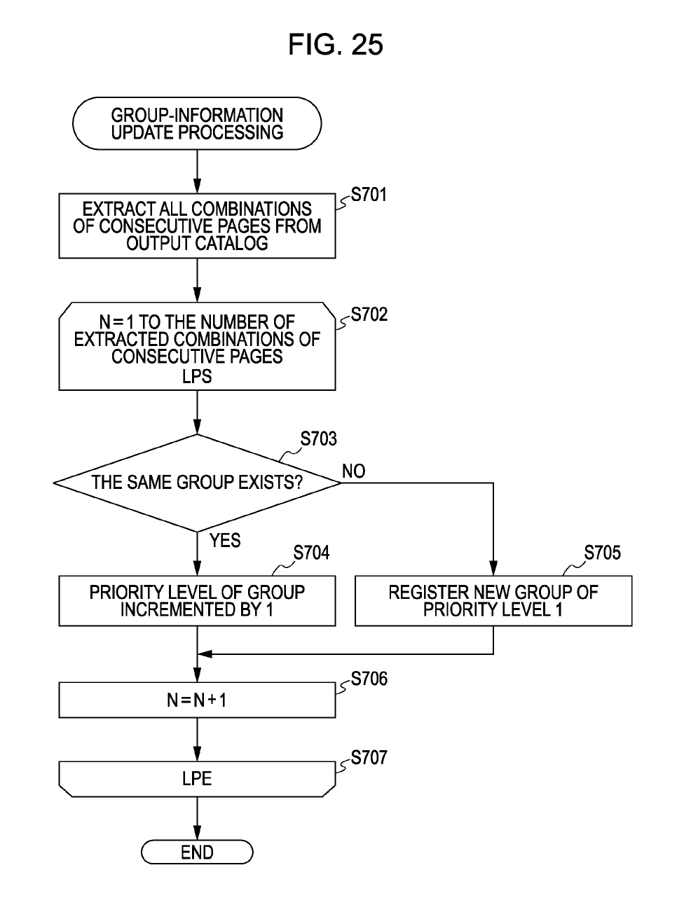

FIG. 25 is a flowchart illustrating a still further data processing procedure of the information processing apparatus according to this embodiment. This example shows an example of processing of updating the group information items performed in step S513. Step S701 to step S707 are realized by loading a module from the hard disk 10 to the PMEM 3 and executing the module by the CPU 2 of the web application server 305.

In step S701, the web application server 305 extracts all combinations of consecutive pages as a certain pattern in which the pages are consecutive in an original catalog and similarly in a catalog to be output. Then, a loop from LPS of step S702 to LPE of step S707 is performed during N=1 to N=(the number of times corresponding to the number of the combinations of consecutive pages). In step S703, the web application server 305 checks whether a group having the same pattern has been registered in accordance with the catalog-group management table 501 and the catalog-group association table 502. When the determination is affirmative, a priority level of the group is incremented by 1 in step S704.

On the other hand, when the determination is negative in step S703, the priority level of the new group is determined to be 1 and is registered in step S705. In step S706, the web application server 305 increments N by 1. When the number of combinations of the pages of the extracted pattern has been reached, the loop is terminated in step S707. This processing is thus terminated.

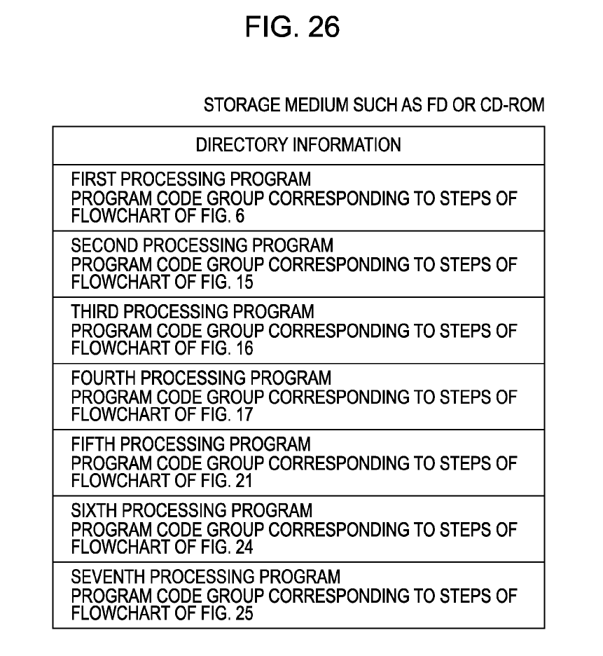

Hereinafter, configurations of data processing programs which are readable by the information processing apparatus according to this embodiment are described with reference to a memory map of FIG. 26.

FIG. 26 is a diagram illustrating the memory map of a computer-readable storage medium which stores various data processing programs which are readable by the information processing apparatus according to this embodiment.

Note that, although not particularly shown, information used to manage program groups stored in the computer-readable storage medium, such as version information and information on a creator, may be also stored in the computer-readable storage medium, and in addition, information which relies on an OS of a program-reading side, such as icons displayed for identifying programs, may be stored in the computer-readable storage medium.

Furthermore, data items associated with various programs are managed in directories of the computer-readable storage medium. Moreover, programs used to install the various programs into a computer or programs used to decompress compressed programs to be installed may be stored in the computer-readable storage medium.

The functions shown in FIGS. 6, 15, 16, 17, 21, 24, and 25 of this embodiment may be executed by a host computer using programs which are externally installed. In this case, the present invention is applicable to a case where information groups including programs are supplied to an output device from a computer-readable storage medium, such as a CD-ROM (Compact Disc Read-Only Memory), a flash memory, or a FD (Flexible Disk), or from an external computer-readable storage medium through a network.

As described above, the computer-readable storage medium including program code of software which realizes the functions of the foregoing embodiment is supplied to the system or the apparatus. It is apparent that an object of the present invention is realized by reading the program code stored in the computer-readable storage medium by a computer (a CPU (Central Processing Unit) or a MPU (Micro Processing Unit)) included in the system or the apparatus.

In this case, the program code itself read from the computer-readable storage medium realizes the functions of the present invention, and therefore, the computer-readable storage medium which stores the program code is included in the present invention.

Accordingly, any program may be used as long as the program functions as a program, and therefore, object code, a program executed by an interpreter, and script data to be supplied to the OS, for example, may be employed.

Examples of the computer-readable storage medium used to supply the programs include a flexible disk, a hard disk, an optical disc, an MO (magnet-optical disc), a CD-ROM, a CD-R (Compact Disc Readable), a CD-RW (Compact Disc ReWritable), a magnetic tape, a nonvolatile memory card, a ROM (Read-Only Memory), and a DVD (Digital Versatile Disc).

In this case, the program code itself read from the computer-readable storage medium realizes the functions of the foregoing embodiment, and the computer-readable storage medium which stores the program code is included in the present invention.

As a method for supplying a program, the user accesses a website on the Internet using a browser of the client PC 301. Then, the computer program of the present invention itself or a compressed file having an auto-installation function may be downloaded in a computer-readable storage medium such as a hard disk. Furthermore, the program code included in the program of the present invention may be divided into a plurality of files, and the files may be downloaded from different websites. That is, a WWW server and an ftp server which allow a plurality of users to download program files which realize functional processing of the present invention are also included in the present invention.

Alternatively, the program of the present invention may be encrypted and stored in a computer-readable storage medium such as a CD-ROM so as to be distributed to users, and only users who satisfy a predetermined condition may be allowed to download key information used to decrypt encryption from a website through the Internet. Then, the encrypted program may be decrypted by the key information, and the decrypted program may be executed and installed in a computer.

It is apparent that the functions of the foregoing embodiment is realized not only by executing the program code read by the computer, but also by executing part of or entire processing using the OS operated in the computer in accordance with an instruction corresponding to the program code, for example. A case where the functions of the foregoing embodiment are realized by such processing is included in the present invention.

Furthermore, the program code read from the computer-readable storage medium may be written in a function expansion board inserted in the computer or a memory included in a function expansion unit connected to the user. Thereafter, in accordance with an instruction corresponding to the program code, the functions of the foregoing embodiment may be realized by executing part of or entire processing using the function expansion board or the CPU included in the function expansion unit.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

Although the various examples and the embodiment are described, spirit and scope of the present invention are not limited to specific descriptions herein.

This application claims the benefit of Japanese Patent Application No. 2008-142449 filed May 30, 2008, which is hereby incorporated by reference herein in its entirety.

What is claimed is:

1. A server apparatus which manages electronic catalogs, comprising:
a storage unit configured to store product information associated with catalog information and a catalog data file including the catalog information, the catalog data file being divided into pages;
a group generation unit configured to analyze the catalog data file which has been divided into pages and to generate different group information items having different properties; and
a registration unit configured to set different priority information items to the different group information items generated by the group generation unit in accordance with the properties and to register the group information items in the storage unit.

2. The server apparatus according to claim 1,
wherein the group generation unit includes a specifying unit configured to specify one of the group information items having the different properties from the catalog information divided into pages.

3. The server apparatus according to claim 1,
wherein the different properties include a content property, a spread property, and a caption property.

4. The server apparatus according to claim 3,
wherein the registration unit registers the catalog data file in the storage unit while the highest priority level is set to the content property, a middle priority level is set to the spread property, and the lowest priority level is set to the caption property.

5. The server apparatus according to claim 4, further comprising:
an updating unit configured to update the priority information items of the content property, the spread property, and the caption property in accordance with a result of searching for the catalog data file registered in the storage unit.

6. The server apparatus according to claim 1, further comprising:
a searching unit configured to search the storage unit for catalog data items registered in the storage unit in order of priority for individual groups in accordance with a selection operation performed by a user using a screen which is used to search for the catalog data items and which is displayed in a display device of a data processing apparatus.

7. The server apparatus according to claim 6,
wherein, among the searched catalog data items, catalog data items which belong to groups having priority levels lower than a preset threshold value are excepted from the result of the searching.

8. The server apparatus according to claim 6, further comprising:
a transmission unit configured to transmit the result of the searching performed by the searching unit to the data processing apparatus.

9. The server apparatus according to claim 1, further comprising:
an association unit configured to associate the catalog data file to be registered in the registration unit with the product information.

10. A catalog processing method of a server apparatus which manages electronic catalogs, the catalog processing method comprising:
a step of analyzing product information associated with catalog information and a catalog data file which includes the catalog information and which is divided into pages, the product information and the catalog data file being stored in a storage unit, and generating different group information items having different properties; and
a step of setting different priority information items to the generated different group information items in accordance with the properties, and registering the group information items in the storage unit.

11. The catalog processing method according to claim 10,
wherein the generating different group information items includes a specifying step of specifying one of the group information items having the different properties from the catalog information divided into pages.

12. The catalog processing method according to claim 10,
wherein the different properties include a content property, a spread property, and a caption property.

13. The catalog processing method according to claim 12,
wherein, in the registering the group information items, the catalog data file is registered in the storage unit while the highest priority level is set to the content property, a middle priority level is set to the spread property, and the lowest priority level is set to the caption property.

14. The catalog processing method according to claim 13, further comprising:
a step of updating the priority information items of the content property, the spread property, and the caption property in accordance with a result of searching for the catalog data file registered in the storage unit.

15. The catalog processing method according to claim 10, further comprising:
a step of searching the storage unit for catalog data items registered in the storage unit in order of priority for individual groups in accordance with a selection operation performed by a user using a screen which is used to search for the catalog data items and which is displayed in a display device of a data processing apparatus.

16. The catalog processing method according to claim 15,
wherein, in the searching step, among the searched catalog data items, catalog data items which belong to groups having priority levels lower than a preset threshold value are excepted from the result of the searching.

17. The catalog processing method according to claim 15, further comprising:
a step of transmitting the result of the searching performed in the searching step to the data processing apparatus.

18. The catalog processing method according to claim 10, further comprising:
a step of associating the catalog data file to be registered in the registering the group information items with the product information.

19. A computer-readable storage medium storing a program which makes a computer execute the catalog processing method set forth in claim 10.
